(19) United States
(12) Patent Application Publication
(10) Pub. No.: US 2022/0219097 A1
(43) Pub. Date: Jul. 14, 2022

(54) PROCESS AND APPARATUS FOR HEATING STREAM FROM A SEPARATION VESSEL

(71) Applicant: UOP LLC, Des Plaines, IL (US)

(72) Inventors: Richard K. Hoehn, Mount Prospect, IL (US); Xin X. Zhu, Long Grove, IL (US); Kiran Ladkat, Gurgaon (IN); Phillip F. Daly, Palatine, IL (US)

(21) Appl. No.: 17/567,734

(22) Filed: Jan. 3, 2022

Related U.S. Application Data
(60) Provisional application No. 63/136,061, filed on Jan. 11, 2021.

(51) Int. Cl. B01D 3/14; C10G 67/04; B01D 3/32; B01D 3/42

(52) U.S. Cl. CPC B01D 3/143; C10G 67/049; F28D 7/024; B01D 3/4227; B01D 3/322

(57) ABSTRACT

An apparatus and process heat a process stream taken from a separator vessel by heat exchange with a hydroprocessed effluent stream and return the heated process stream to the separator vessel. We have found the significant heater duty reduction is provided particularly for a hydroprocessing unit. A spiral tube heat exchange can achieve heating of an already hot process stream by heat exchange with a hot effluent stream.

### CROSS-REFERENCE TO RELATED APPLICATIONS

This application claims priority from U.S. Provisional Application No. 63/136,061, filed Jan. 11, 2021, which is incorporated herein in its entirety.

### FIELD

The field is hydroprocessing and separating hydrocarbon streams.

### BACKGROUND

Hydroprocessing can include processes which convert hydrocarbons in the presence of hydroprocessing catalyst and hydrogen to more valuable products.

Hydrotreating is a hydroprocessing process used to remove heteroatoms such as sulfur and nitrogen from hydrocarbon streams to meet fuel specifications and to saturate olefinic compounds. Hydrotreating can be performed at high or low pressures but is typically operated at lower pressure than hydrocracking.

Hydrocracking is a hydroprocessing process in which hydrocarbons crack in the presence of hydrogen and hydrocracking catalyst to lower molecular weight hydrocarbons. Depending on the desired output, a hydrocracking unit may contain one or more beds of the same or different catalyst. Hydrocracking can be performed with one or two hydrocracking reactor stages.

A hydroprocessing recovery section typically includes a series of separators in a separation section to separate gases from the liquid materials and cool and depressurize liquid streams to prepare them for fractionation into products. Hydrogen gas is recovered for recycle to the hydroprocessing unit. A stripping column for stripping hydroprocessed effluent with a stripping medium such as steam is used to remove unwanted hydrogen sulfide from liquid product streams. A stripping column may be sufficient to separate product streams from a hydrotreating unit. A product fractionation column downstream of the stripping column is typically used to separate product streams from a hydrocracking unit.

A spiral tube heat exchanger comprises a vertical shell in which one or more bundles of tubes are helically or spirally wound around a central core or mandrels in numerous superposed layers. The spiral tube heat exchange can exchange heat between a stream circulating in the shell and a stream circulating in the tube. The numerous spiral tubes provide a greater quantity of surface area enabling heat exchange between streams with a lower temperature differential.

There is a continuing need, of imparting heat to streams in product recovery and appurtenant to the hydroprocessing reactor.

### BRIEF SUMMARY

An apparatus and process heat a process stream taken from a separator vessel by heat exchange with a hydroprocessed effluent stream and return the heated process stream to the separator vessel. We have found the significant heater duty reduction is provided by this arrangement particularly for a hydroprocessing unit. A spiral tube heat exchanger can achieve heating of an already hot process stream by heat exchange with a hot effluent stream to make this arrangement work in a hydroprocessing unit.

### BRIEF DESCRIPTION OF THE DRAWINGS

FIG. 1 is a simplified process flow diagram.

FIG. 2 is an alternative process flow diagram to FIG. 1.

FIG. 3 is a further alternative process flow diagram to FIG. 2.

### DEFINITIONS

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without passing through a fractionation or conversion unit to undergo a compositional change due to physical fractionation or chemical conversion.

The term “bypass” means that the object is out of downstream communication with a bypassing subject at least to the extent of bypassing.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns omit a reboiler at a bottom of the column and instead provide heating requirements and separation impetus from a fluidized inert media such as steam.

As used herein, the term “True Boiling Point” (TBP) means a test method for determining the boiling point of a material which corresponds to ASTM D2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “boiling point temperature” means atmospheric equivalent boiling point (AEBP) as calculated from the observed boiling temperature and the distillation pressure, as calculated using the equations furnished in ASTM D1160 appendix A7 entitled “Practice for Converting Observed Vapor Temperatures to Atmospheric Equivalent Temperatures”.

As used herein, the term “T5” or “T95” means the temperature at which 5 vol percent or 95 mass percent, as the case may be, respectively, of the sample boils using ASTM D-86 or TBP.

As used herein, the term “initial boiling point” (IBP) means the temperature at which the sample begins to boil using ASTM D2892, ASTM D-86 or TBP, as the case may be.

As used herein, the term “conversion” means conversion of feed to material that boils at or below the diesel or the heaviest desired product boiling range. The diesel cut point of the diesel boiling range is between about 343° and about 399° C. (650° to 750° F.) using the True Boiling Point distillation method.

As used herein, the term “diesel boiling range” means hydrocarbons boiling in the range of between about 132° and about 399° C. (270° to 750° F.) using the True Boiling Point distillation method.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant”, “predominantly” or “predominate” means greater than 50%, suitably greater than 75% and preferably greater than 90%.

As used herein, the term “pass” is a flow of a specific stream through a heat exchanger.

As used herein, the term “bundle” is a group of tubes or channels containing a specific stream and comprising a pass through a heat exchanger.

### DETAILED DESCRIPTION

We have found that heating a process stream taken from a separation vessel and returning the stream back to the separation vessel significantly reduces heater duty in the separation vessel. The process is well suited for a hydroprocessing unit. Additionally, we have found that heat exchanging the already hot process stream from the separation vessel with another hotter stream can be achieved in a spiral tube heat exchanger.

In one aspect, the process and apparatus described herein are particularly useful for hydroprocessing a hydrocarbon feed stream comprising a hydrocarbonaceous feedstock. Illustrative hydrocarbonaceous feed stocks particularly for hydroprocessing units having a hydroprocessing reactor 12 include hydrocarbon streams having initial boiling points (IBP) above about 260° C. (500° F.), such as atmospheric gas oil or vacuum gas oil (VGO) having T5 between about 288° C. (550° F.) and about 427° C. (800° F.) and a T95 between about 371° C. (700° F.) and about 650° C. (1200° F.). Distillates including cycle oils, coker distillates, straight run distillates, catalytic cracker distillates and hydrocracked distillates boiling in the diesel boiling range are suitable feedstocks. Other suitable feeds include deasphalted oil, pyrolysis-derived oils, high boiling synthetic oils, clarified slurry oils, deasphalted oil, and shale oil. Atmospheric residue having a T5 at or above about 343° C. (650° F.) and vacuum residue having a T5 above about 510° C. (950° F.) are also suitable.

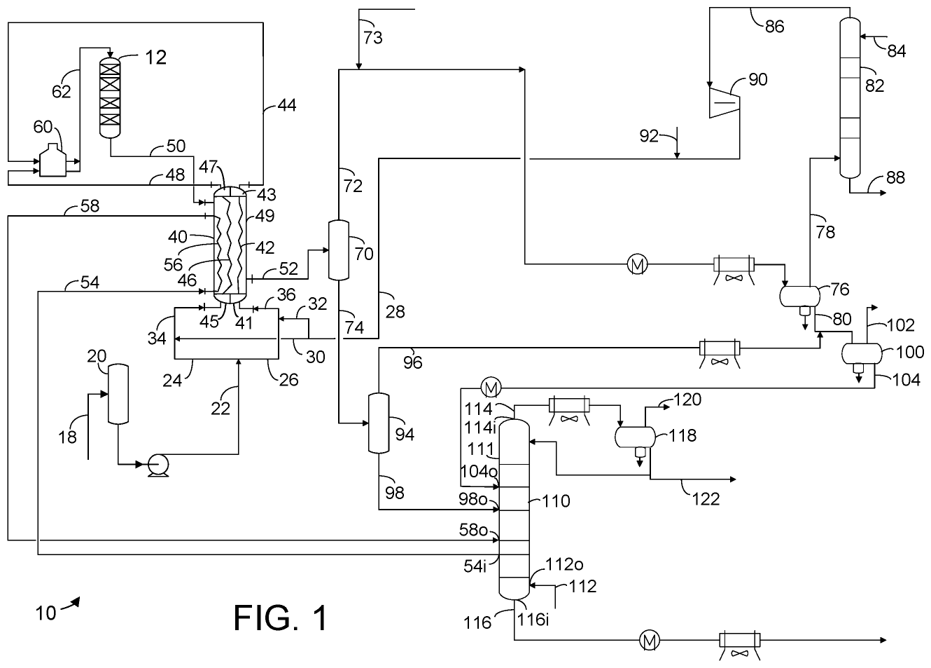

In FIG. 1, the hydroprocessing unit 10 for hydroprocessing hydrocarbons comprises a hydroprocessing reactor 12. A hydrocarbon feed stream in hydrocarbon line 18 may be fed to a surge drum 20 from which it is pumped to a manifold in line 22 and split into a first hydrocarbon feed stream in line 24 and a second hydrocarbon feed stream in line 26. The first hydrocarbon feed stream and the second hydrocarbon feed stream should be of equal flow rates. The hydrocarbon feed stream may be split into additional streams of equal flow rates. A hydrogen stream in line 28 is also split into a first hydrogen stream in line 30 and a second hydrogen stream in line 32 of equal flow rates. The hydrogen stream 28 may be split into as many streams as the hydrocarbon feed stream in line 22 is split. The first hydrogen stream in line 30 may be combined with the first hydrocarbon feed stream in line 24 to provide a first combined hydrocarbon stream in line 34. The second hydrogen stream in line 32 may be combined with the second hydrocarbon feed stream in line 26 to provide a second combined hydrocarbon stream in line 36.

The first combined hydrocarbon stream in line 34 and the second combined hydrocarbon stream in line 36 are fed to a heat exchanger 40. The first combined hydrocarbon stream is fed to a first inlet compartment 41 which feeds the first combined hydrocarbon stream into a first pass 42 in which it is indirectly heat exchanged through the first pass and collects in a first outlet compartment 43. Alternatively, the first hydrogen stream in line 30 may be combined with the first hydrocarbon feed stream in line 24 in the first inlet compartment 41 to allow mixing or distribution of the streams in the first inlet compartment. The first inlet compartment 41 may be in the bottom of the heat exchanger 40 and the first outlet compartment 43 may be in the top of the heat exchanger. A first heated combined hydrocarbon stream exits the heat exchanger 40 in line 44. The second combined hydrocarbon stream is fed to a second inlet compartment 45 which feeds the second combined hydrocarbon stream into a second pass 46 in which it is indirectly heat exchanged through the second pass and collects in a second outlet compartment 47. Alternatively, the second hydrogen stream in line 32 may be combined with the second hydrocarbon feed stream in line 26 in the second inlet compartment 45 to allow mixing or distribution of the streams in the second inlet compartment. The second inlet compartment 45 may be in the bottom of the heat exchanger 40 and the second outlet compartment 47 may be in the top of the heat exchanger. A second heated combined hydrocarbon stream exits the heat exchanger 40 in line 48. The first combined hydrocarbon stream and the second combined hydrocarbon stream are heat exchanged with a hot hydroprocessed effluent stream in line 50 from the hydroprocessing reactor 12 which may be circulated through the shell side of the heat exchanger 40. The shell 49 of the heat exchanger 40 may be in downstream communication with the hydroprocessing reactor 12. A cooled hydroprocessed effluent stream exits the heat exchanger 40 in line 52. The hotter hydroprocessed effluent passes through the shell 49 counter-currently to the passage of the cooler hydrocarbon feed streams through the passes 42 and 46. In a non-tubular heat exchanger, the hot hydroprocessed effluent stream can pass through channels arranged in thermal contact to channels through with the combined hydrocarbon feed stream passes. In an aspect the cool hydrocarbon feed streams pass upwardly and the hot hydroprocessed effluent stream passes downwardly in the heat exchanger 40.

In an aspect, a process stream in line 54 may also be heated by heat exchange with the hydroprocessed effluent stream in line 50. In an aspect, the process stream in line 54 may be heated by heat exchange with the hydroprocessed effluent stream in line 50 simultaneously with the heat exchange of the first combined hydrocarbon stream and the second combined hydrocarbon stream with the hydroprocessed effluent stream in line 50 in the heat exchanger 40. The process stream in line 54 may pass through a third pass 56 in the heat exchanger 40 while it is heat exchanged with the hotter hydroprocessed effluent stream from line 50. A heated process stream exits the heat exchanger 40 in line 58. Preferably, the heat exchange in the heat exchanger 40 is all conducted within the shell 49 of the heat exchanger 40. The hotter hydroprocessed effluent passes through the shell 49 counter-currently to the passage of the cooler process stream through the third pass 56. In an aspect the cool process stream passes upwardly and the hot hydroprocessed effluent stream passes downwardly in the heat exchanger 40.

The heat exchanger 40 may be any heat exchanger or heat exchange train that can achieve the heat exchange of all the mentioned streams. For example, the heat exchanger 40 may be a plate exchanger which has sufficient surface area to provide heat exchange between streams with lower temperature differentials. Plate exchangers may enable a specific stream to make multiple passes through a heat exchanger. In a further aspect, the heat exchanger 40 may be a spiral tube heat exchanger (STHE). A STHE comprises a vertical chamber within the shell 49 in which one or more bundles of tubes are helically or spirally wound around a central core or mandrel in numerous superposed layers. Each pass 42, 46 and 56 in the heat exchanger 40 may comprise a bundle of tubes spirally wound around a mandrel. While the tube side of each bundle is in communication with only the streams identified at the inlet and outlet of the pass, the tubes of each bundle may be co-arranged with other bundles within wound layers around a single mandrel to maximize heat transfer. The high surface area and flow arrangement afforded by the bundle of spirally wound tubes permits the process stream in line 54 ranging in temperature from about 230° C. (450° F.) to about 315° C. (600° F.) to be heat exchanged against the hydroprocessed effluent stream in line 50 at a temperature ranging from about 290° C. (550° F.) to about 468° C. (875° F.), suitably 316° C. (600° F.) to about 445° C. (833° F.) and preferably 343° C. (650° F.) to about 399° C. (750° F.).

The first heated combined hydrocarbon stream in line 44 and the second heated combined hydrocarbon stream in line 48 exit the heat exchanger 40 and are separately fed to the charge heater 60 in which they are heated to hydroprocessing reactor temperature and recombined in a hydroprocessing charge line 62. The hydroprocessing charge line 62 delivers the charge hydrocarbon feed stream to the hydroprocessing reactor 12.

Hydroprocessing that occurs in the hydroprocessing reactor 12 may be hydrotreating or hydrocracking. The embodiment of FIG. 1 is most suited for hydrotreating a distillate feed stream in the hydroprocessing reactor 12. Hydrotreating is a process in which hydrogen is contacted with hydrocarbon in the presence of suitable catalysts which are primarily active for the removal of heteroatoms, such as sulfur, nitrogen and metals from the hydrocarbon feedstock. In hydrotreating, hydrocarbons with double and triple bonds may be saturated. Aromatics may also be saturated. Some hydrotreating processes are specifically designed to saturate aromatics. The cloud point of the hydrotreated product may also be reduced. The hydroprocessing unit 10 will be described with the hydroprocessing reactor 12 comprising a hydrotreating reactor.

The hydroprocessing reactor 12 may be a fixed bed reactor that comprises one or more vessels, single or multiple beds of catalyst in each vessel, and various combinations of hydrotreating catalyst in one or more vessels. It is contemplated that the hydroprocessing reactor 12 be operated in a continuous liquid phase in which the volume of the liquid hydrocarbon feed is greater than the volume of the hydrogen gas. The hydroprocessing reactor 12 may also be operated in a conventional continuous gas phase, a moving bed or a fluidized bed hydrotreating reactor. The hydroprocessing reactor 12 may provide conversion per pass of about 5 to about 40 vol %.

The hydroprocessing reactor 12 may comprise a guard bed of specialized material for pressure drop mitigation followed by one or more beds of higher quality hydrotreating catalyst. The guard bed filters particulates and picks up contaminants in the hydrocarbon feed stream such as metals like nickel, vanadium, silicon and arsenic which deactivate the catalyst. The guard bed may comprise material similar to the hydrotreating catalyst. Supplemental hydrogen may be added at an interstage location between catalyst beds in the hydrotreating reactor 12 for temperature control.

Suitable hydrotreating catalysts are any known conventional hydrotreating catalysts and include those which are comprised of at least one Group VIII metal, preferably iron, cobalt and nickel, more preferably cobalt and/or nickel and at least one Group VI metal, preferably molybdenum and tungsten, on a high surface area support material, preferably alumina. Other suitable hydrotreating catalysts include zeolitic catalysts, as well as noble metal catalysts where the noble metal is selected from palladium and platinum. It is within the scope of the present description that more than one type of hydrotreating catalyst be used in the same hydrotreating reactor 30. The Group VIII metal is typically present in an amount ranging from about 2 to about 20 wt %, preferably from about 4 to about 12 wt %. The Group VI metal will typically be present in an amount ranging from about 1 to about 25 wt %, preferably from about 2 to about 25 wt %.

Preferred hydrotreating reaction conditions include a temperature from about 290° C. (550° F.) to about 455° C. (850° F.), suitably 316° C. (600° F.) to about 427° C. (800° F.) and preferably 343° C. (650° F.) to about 399° C. (750° F.), a pressure from about 2.8 MPa (gauge) (400 psig) to about 17.5 MPa (gauge) (2500 psig), a liquid hourly space velocity of the fresh hydrocarbonaceous feedstock from about 0.1 hr⁻¹, suitably 0.5 hr⁻¹, to about 5 hr⁻¹, preferably from about 1.5 to about 4 hr⁻¹, and a hydrogen rate of about 84 Nm³/m³ (500 scf/bbl), to about 1,011 Nm³/m³ oil (6,000 scf/bbl), preferably about 168 Nm³/m³ oil (1,000 scf/bbl) to about 1,250 Nm³/m³ oil (7,500 scf/bbl), with a hydrotreating catalyst or a combination of hydrotreating catalysts.

The charge hydrocarbon feed stream in the hydroprocessing charge line 62 may be hydroprocessed in the hydroprocessing reactor 12 with the hydrogen stream over hydroprocessing catalyst to provide a hydroprocessed effluent stream. Specifically, the charge hydrocarbon feed stream in the hydroprocessing charge line 62 may be hydrotreated with the hydrogen stream over the hydrotreating catalyst in the hydroprocessing reactor 12 to provide the hydroprocessed effluent stream that exits the hydroprocessing reactor in a hydroprocessed effluent line 50. The hydroprocessed effluent stream may exit the hydroprocessing reactor 12 in the hydroprocessed effluent line 50 and be cooled in the heat exchanger 40 as previously described. The shell 49 of the heat exchanger 40 may be in downstream communication with the hydroprocessing reactor 12. It is alternatively contemplated that the hydroprocessed effluent stream may be received through a pass of the heat exchanger 40 which may be in direct downstream communication with the hydroprocessing reactor 12. The cooled hydroprocessed effluent exits the heat exchanger 40 and enters a hot separator 70.

The hot separator 70 separates the cooled hydroprocessed effluent stream to provide a hydrocarbonaceous, hot hydroprocessed vapor stream in a hot overhead line 72 extending from a top of the hot separator 70 and a hydrocarbonaceous, hot liquid stream in a hot bottoms line 74 extending from a bottom of the hot separator 70. The hot separator 70 may be in downstream communication with the hydroprocessing reactor 12. The hot separator 70 operates at about 177° C. (350° F.) to about 371° C. (700° F.) and preferably operates at about 232° C. (450° F.) to about 315° C. (600° F.). The hot separator 70 may be operated at a slightly lower pressure than the hydroprocessing reactor 12 accounting for pressure drop through intervening equipment. The hot separator 70 may be operated at pressures between about 3.4 MPa (gauge) (493 psig) and about 20.4 MPa (gauge) (2960 psig). The hot hydroprocessed vapor stream taken in the hot overhead line 72 may have a temperature of the operating temperature of the hot separator 70.

The hot vapor stream in the hot overhead line 72 may be cooled by heat exchange and with an air cooler before entering a cold separator 76. As a consequence of the reactions taking place in the hydroprocessing reactor 12 wherein nitrogen, chlorine and sulfur are reacted from the hydrocarbons in the feed, ammonia, hydrogen sulfide and hydrogen chloride are formed. At a characteristic sublimation temperature, ammonia and hydrogen sulfide will combine to form ammonium bisulfide, and ammonia and hydrogen chloride will combine to form ammonium chloride. Each compound has a characteristic sublimation temperature that may allow the compound to coat equipment, particularly heat exchange equipment, impairing its performance. To prevent such deposition of ammonium bisulfide or ammonium chloride salts in the hot overhead line 72 transporting the hot vapor stream, a suitable amount of wash water may be introduced into the hot overhead line 72 upstream of the air cooler by water line 73 at a point in the hot overhead line where the temperature is above the characteristic sublimation temperature of either compound.

The hot vapor stream may be separated in the cold separator 76 to provide a cold hydroprocessed vapor stream comprising a hydrogen-rich gas stream in a cold overhead line 78 extending from a top of the cold separator 76 and a cold hydroprocessed liquid stream in a cold bottoms line 80 extending from a bottom of the cold separator 76. The cold separator 76 serves to separate hydrogen rich gas from hydrocarbon liquid in the hydroprocessed stream for recycle to the reactor section 12 in the cold overhead line 78. The cold separator 76, therefore, is in downstream communication with the hot overhead line 72 of the hot separator 70 and the hydroprocessing reactor 12. The cold separator 76 may be operated at about 100° F. (38° C.) to about 150° F. (66° C.), suitably about 115° F. (46° C.) to about 145° F. (63° C.), and just below the pressure of the hydroprocessing reactor 12 and the hot separator 70 accounting for pressure drop through intervening equipment to keep hydrogen and light gases in the overhead and normally liquid hydrocarbons in the bottoms. The cold separator 76 may be operated at pressures between about 3 MPa (gauge) (435 psig) and about 20 MPa (gauge) (2,900 psig). The cold separator 76 may also have a boot for collecting an aqueous phase. The cold hydroprocessed liquid stream in the cold bottoms line 80 may have a temperature of the operating temperature of the cold separator 76.

The cold hydroprocessed vapor stream in the cold overhead line 78 is rich in hydrogen. Thus, hydrogen can be recovered from the cold hydroprocessed vapor stream. The cold hydroprocessed vapor stream in the cold overhead line 78 may be passed through a trayed or packed recycle scrubbing column 82 where it is scrubbed by means of a scrubbing extraction liquid such as an aqueous solution fed by line 84 to remove acid gases including hydrogen sulfide by extracting them into the aqueous solution. Preferred extraction liquids include Selexol available from UOP LLC in Des Plaines, Ill. and amines such as alkanolamines including diethanol amine (DEA), monoethanol amine (MEA), methyl diethanol amine (MDEA), diisopropanol amine (DIPA), and diglycol amine (DGA). Other amines can be used in place of or in addition to the preferred amines. The lean amine contacts the cold hydroprocessed vapor stream and absorbs acid gas contaminants such as hydrogen sulfide. The resultant “sweetened” cold vapor stream is taken out from an overhead outlet of the recycle scrubber column 82 in a recycle scrubber overhead line 86, and a rich amine is taken out from the bottoms at a bottom outlet of the recycle scrubber column in a recycle scrubber bottoms line 88. The spent scrubbing liquid from the bottoms may be regenerated and recycled back to the recycle scrubbing column 82 in the solvent line 84. The scrubbed hydrogen-rich stream emerges from the scrubber via the recycle scrubber overhead line 86 and may be compressed in a recycle compressor 90. The scrubbed hydrogen-rich stream in the scrubber overhead line 86 may be supplemented with make-up hydrogen stream in the make-up line 92 upstream or downstream of the compressor 90. The compressed hydrogen stream supplies hydrogen to the hydrogen stream in the hydrogen line 28. The recycle scrubbing column 82 may be operated with a gas inlet temperature between about 38° C. (100° F.) and about 66° C. (150° F.) and an overhead pressure of about 3 MPa (gauge) (435 psig) to about 20 MPa (gauge) (2900 psig). The temperature of the scrubbing extraction liquid stream in the solvent line 84 may be between about 38° C. (100° F.) and about 70° C. (158° F.).

The hydrocarbonaceous hot hydroprocessed liquid stream in the hot bottoms line 74 may be let down in pressure and fed to a hot flash drum 94. The hot flash drum 94 separates a hot flash hydroprocessed vapor stream of light ends and hydrogen in a hot flash overhead line 96 extending from a top of the hot flash drum and a hot flash hydroprocessed liquid stream in a hot flash bottoms line 98 extending from a bottom of the hot flash drum 94. The hot flash drum 94 may be in downstream communication with the hot bottoms line 74 and in downstream communication with the hydroprocessing reactor 12. The hot flash drum 94 may be operated at the same temperature as the hot separator 70 but at a lower pressure of between about 1.4 MPa (gauge) (200 psig) and about 6.9 MPa (gauge) (1000 psig), suitably no more than about 3.8 MPa (gauge) (550 psig). The hot flash hydroprocessed liquid stream taken in the hot flash bottoms line 98 may have a temperature of the operating temperature of the hot flash drum 94.

In an aspect, the cold hydroprocessed liquid stream in the cold bottoms line 80 may be let down in pressure and flashed in a cold flash drum 100 to separate the cold hydroprocessed liquid stream in the cold bottoms line 80. The cold flash drum 100 may be in direct, downstream communication with the cold bottoms line 80 of the cold separator 76 and in downstream communication with the hydroprocessing reactor 12. The cold flash drum 100 may separate the cold hydroprocessed liquid stream in the cold bottoms line 80 to provide a cold flash hydroprocessed vapor stream in a cold flash overhead line 102 extending from a top of the cold flash drum 100 and a cold flash hydroprocessed liquid stream in a cold flash bottoms line 104 extending from a bottom of the cold flash drum. In an aspect, light gases such as hydrogen sulfide may be stripped from the cold flash hydroprocessed liquid stream in the cold flash bottoms line 104. Accordingly, a stripping column 110 comprising a separation vessel of this embodiment may be in downstream communication with the cold flash drum 100 and the cold flash bottoms line 104.

The cold flash drum 100 may be in downstream communication with the cold bottoms line 80 of the cold separator 76 and the hydroprocessing reactor 12. The cold flash drum 100 may be operated at the same temperature as the cold separator 76 but typically at a lower pressure of between about 1.4 MPa (gauge) (200 psig) and about 6.9 MPa (gauge) (1000 psig) and preferably between about 2.4 MPa (gauge) (350 psig) and about 3.8 MPa (gauge) (550 psig). A flashed aqueous stream may be removed from a boot in the cold flash drum 100. The cold flash hydroprocessed liquid stream in the cold flash bottoms line 104 may have the same temperature as the operating temperature of the cold flash drum 100. The cold flash hydroprocessed vapor stream in the cold flash overhead line 102 contains substantial hydrogen that may be recovered.

In an embodiment, the hot flash hydroprocessed vapor stream may be cooled in a cooler to condense heavier materials and fed to the cold flash drum 100 to be flashed with the cold hydroprocessed liquid stream in the cold bottoms line 80. In an aspect, the cold bottoms line 80 may be joined by the hot flash overhead line 96 and receive the cooled hot flash hydroprocessed vapor stream in which case the cold bottoms line 80 delivers both streams, the cooled, hot flash hydroprocessed vapor stream and the cold hydroprocessed liquid stream, to the cold flash drum 100. In this embodiment, the cold flash drum 100 may be in downstream communication with the hot flash overhead line 96 of the hot flash drum 94.

The stripping column 110 may be in downstream communication with a separator 70, 76, 94, 100 or a bottoms line thereof for stripping volatile materials from the hydroprocessed stream. For example, the separation vessel may be the stripping column 110. In an aspect, the stripping column 110 may be a separation vessel that contains a cold stripping column and a hot stripping column with a wall that isolates each of the stripping columns from the other. The stripping column 110 may be in downstream communication with the hydroprocessing reactor 12 for stripping a cold hydroprocessed liquid stream comprising either the cold hydroprocessed liquid stream in line 80 or the cold flash hydroprocessed liquid stream in line 104. The stripping column 110 may be in downstream communication with the hydroprocessing reactor 12 for stripping a hot hydroprocessed liquid stream comprising either the hot hydroprocessed liquid stream in line 74 or the hot flash hydroprocessed liquid stream in line 98.

The cold hydroprocessed liquid stream in the cold bottoms line 80 or the cold flash hydroprocessed liquid stream in the cold flash bottoms line 104 may be heated and fed to the stripping column 110 at an outlet 104o which may be in a top half of the column. The hot hydroprocessed liquid stream in the hot bottoms line 74 or the hot flash hydroprocessed liquid stream in the hot flash bottoms line 98 may be fed to the stripping column 110 at an outlet 98o below the inlet 104o for the cold hydroprocessed liquid stream. The cold hydroprocessed liquid stream or the cold flash hydroprocessed liquid stream and the hot hydroprocessed liquid stream or the hot flash hydroprocessed liquid stream may be stripped of gases by contact with a stripping media which is an inert gas such as steam from a stripping media line 112 to provide an overhead vapor stream of naphtha, hydrogen, hydrogen sulfide, steam and other gases in a separator overhead line 114 and a bottoms liquid stream in a separator bottoms line 116. The separator overhead vapor stream in the separator overhead line 114 may be condensed and separated in a receiver 118. A stripper net overhead line 120 from a stripper receiver 118 carries a net separator off gas of LPG, light hydrocarbons, hydrogen sulfide and hydrogen. Unstabilized liquid naphtha from the bottoms of the receiver 118 may be split between a reflux portion refluxed to the top of the stripping column 110 and a liquid stripper overhead stream which may be transported in a condensed stripper overhead line 122 to further recovery or processing. A sour water stream may be collected from a boot of the overhead receiver 118. A product stream is provided in the bottoms liquid stream in the separator bottoms line 116 after cooling. The product stream is typically diesel in this embodiment and may be forwarded to a diesel product pool.

The stripping column 110 may be operated with a bottoms temperature between about 160° C. (320° F.) and about 360° C. (680° F.) and an overhead pressure of about 0.7 MPa (gauge) (100 psig), preferably no less than about 0.34 MPa (gauge) (50 psig), to no more than about 2.0 MPa (gauge) (290 psig). The temperature in the overhead receiver 116 ranges from about 38° C. (100° F.) to about 66° C. (150° F.) and the pressure is essentially the same as in the overhead of the stripping column 110.

To reduce utilities in the separation vessel comprising the stripping column 110, the process stream in the process line 54 is taken from the stripping column 110 and heated in the heat exchanger 40. The process stream is fed through the third pass 56 and heat exchanged with the hydroprocessed effluent stream in line 50 from the hydroprocessing reactor 12 traveling through the shell side of the heat exchanger 40. The heat exchanger 40 and particularly the third pass 56 may be in downstream communication, preferably direct downstream communication, with the stripping column 110. The process stream in line 54 may be taken from an inlet 54i in a side 111 of the stripping column 110 and between an inlet 114i for the overhead line 114 and an inlet 116i for the bottoms line 116 and preferably below an outlet 98o of the hot flash liquid hydroprocessed stream in line 98 and an outlet 104o for the cold flash liquid hydroprocessed stream in line 104 and preferably above an outlet 112o for the stripping stream in line 112 to the stripping column 110. The process stream may have an initial boiling point that is intermediate to an initial boiling point of the overhead vapor stream and the bottoms liquid stream. The process stream in the process line 54 is preferably taken as a liquid from a tray in the stripping column 110. The process stream is heated in the third pass 56 in the heat exchanger 40 and returned in the return process line 58 to the stripping column 110 through an inlet 58i above the outlet 54i. The stripping column 110 may be in downstream communication, preferably direct downstream communication, with the heat exchanger 40 and particularly the third pass 56 of the heat exchanger.

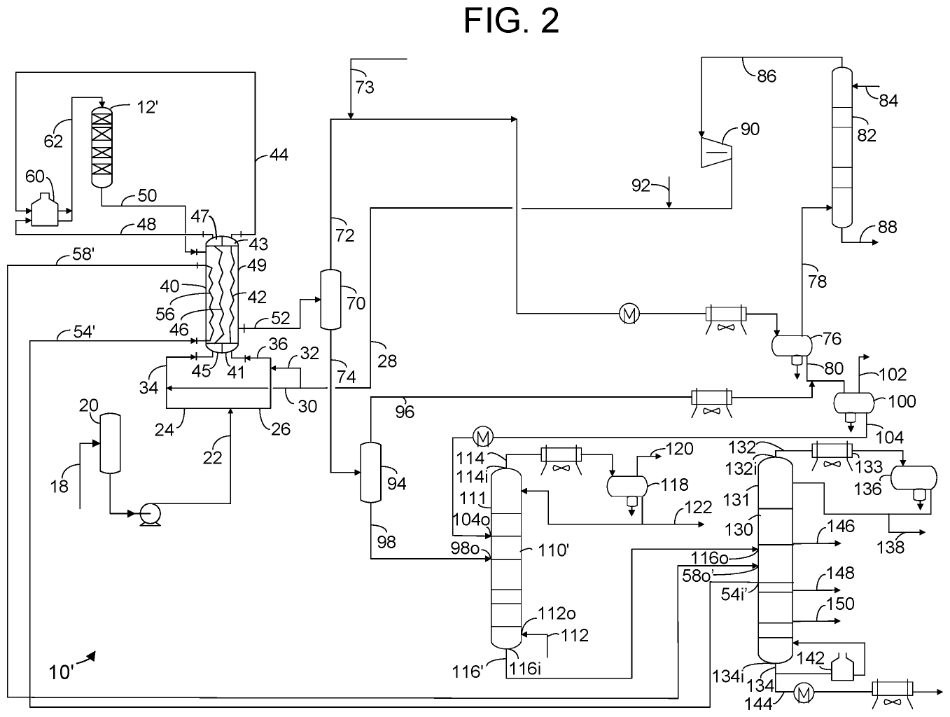

FIG. 2 shows an alternate embodiment of the process and apparatus of FIG. 1 in which the hydroprocessing reactor 12′ is a hydrocracking reactor and the separator vessel is a product fractionation column 130. Elements in FIG. 2 with the same configuration as in FIG. 1 will have the same reference numeral as in FIG. 1. Elements in FIG. 2 which have a different configuration as the corresponding element in FIG. 1 will have the same reference numeral but designated with a prime symbol (′). The configuration and operation of the embodiment of FIG. 2 is similar to FIG. 1 with the following exceptions.

In the embodiment of FIG. 2, the hydroprocessing reactor 12′ is a hydrocracking reactor that can accommodate any of the previously listed feedstocks. Hydrocracking refers to a process in which hydrocarbons crack in the presence of hydrogen to lower molecular weight hydrocarbons. Consequently, the term “hydroprocessing” will include the term “hydrocracking” herein. Hydroprocessing that occurs in the hydroprocessing reactor 12′ may also comprise hydrotreating that precedes hydrocracking in the same hydroprocessing reactor 12′ or in separate reactors.

The hydroprocessing reactor 12′ may be a fixed bed reactor that comprises one or more vessels, single or multiple catalyst beds in each vessel, and various combinations of hydrotreating catalyst and/or hydrocracking catalyst in one or more vessels. It is contemplated that the hydroprocessing reactor 12′ be operated in a continuous liquid phase in which the volume of the liquid hydrocarbon feed is greater than the volume of the hydrogen gas. The hydroprocessing reactor 12′ may also be operated in a conventional continuous gas phase, a moving bed or a fluidized bed hydroprocessing reactor.

The hydroprocessing reactor 12′ comprises a plurality of hydrocracking catalyst beds. If the hydroprocessing reactor 12′ does not include a preceding hydrotreating reactor, the catalyst beds in the hydroprocessing reactor 12′ may include a hydrotreating catalyst for the purpose of saturating, demetallizing, desulfurizing or denitrogenating the hydrocarbon feed stream before it is hydrocracked with the hydrocracking catalyst in subsequent vessels or catalyst beds in the hydroprocessing reactor 12′.

The hydroprocessing charge line 62 delivers the heated charge hydrocarbon feed stream to the hydroprocessing reactor 12′. The heated charge hydrocarbon feed stream is hydrocracked over a hydrocracking catalyst in the hydroprocessing reactor 12′ in the presence of a hydrogen stream to provide a hydroprocessed effluent stream.

The hydroprocessing reactor 12′ may provide a total conversion of at least about 20 vol % and typically greater than about 60 vol % of the charged hydrocarbon stream in the heated combined hydrocarbon feed stream in the charge line 62 to products boiling below the cut point of the heaviest desired product which is typically diesel. The hydroprocessing reactor 12′ may operate at partial conversion of more than about 30 vol % or full conversion of at least about 90 vol % of the feed based on total conversion. The hydroprocessing reactor 12′ may be operated at mild hydrocracking conditions which will provide about 20 to about 60 vol %, preferably about 20 to about 50 vol %, total conversion of the hydrocarbon feed stream to product boiling below the diesel cut point.

The hydrocracking catalyst may utilize amorphous silica-alumina bases or low-level zeolite bases combined with one or more Group VIII or Group VIB metal hydrogenating components if mild hydrocracking is desired to produce a balance of middle distillate and gasoline. In another aspect, when middle distillate is significantly preferred in the converted product over gasoline production, partial or full hydrocracking may be performed in the hydroprocessing reactor 12′ with a catalyst which comprises, in general, any crystalline zeolite cracking base upon which is deposited a Group VIII metal hydrogenating component. Additional hydrogenating components may be selected from Group VIB for incorporation with the zeolite base.

The zeolite cracking bases are sometimes referred to in the art as molecular sieves and are usually composed of silica, alumina and one or more exchangeable cations such as sodium, magnesium, calcium, rare earth metals, etc. They are further characterized by crystal pores of relatively uniform diameter between about 4 and about 14 Angstroms. It is preferred to employ zeolites having a relatively high silica/alumina mole ratio between about 3 and about 12. Suitable zeolites found in nature include, for example, mordenite, stilbite, heulandite, ferrierite, dachiardite, chabazite, erionite and faujasite. Suitable synthetic zeolites include, for example, the B, X, Y and L crystal types, e.g., synthetic faujasite and mordenite. The preferred zeolites are those having crystal pore diameters between about 8 and 12 Angstroms, wherein the silica/alumina mole ratio is about 4 to 6. One example of a zeolite falling in the preferred group is synthetic Y molecular sieve.

The natural occurring zeolites are normally found in a sodium form, an alkaline earth metal form, or mixed forms. The synthetic zeolites are nearly always prepared in the sodium form. In any case, for use as a cracking base it is preferred that most or all of the original zeolitic monovalent metals be ion-exchanged with a polyvalent metal and/or with an ammonium salt followed by heating to decompose the ammonium ions associated with the zeolite, leaving in their place hydrogen ions and/or exchange sites which have actually been decationized by further removal of water. Hydrogen or “decationized” Y zeolites of this nature are more particularly described in U.S. Pat. No. 3,100,006.

Mixed polyvalent metal-hydrogen zeolites may be prepared by ion-exchanging with an ammonium salt, then partially back exchanging with a polyvalent metal salt and then calcining. In some cases, as in the case of synthetic mordenite, the hydrogen forms can be prepared by direct acid treatment of the alkali metal zeolites. In one aspect, the preferred cracking bases are those which are at least about 10 wt %, and preferably at least about 20 wt %, metal-cation-deficient, based on the initial ion-exchange capacity. In another aspect, a desirable and stable class of zeolites is one wherein at least about 20 wt % of the ion exchange capacity is satisfied by hydrogen ions.

The active metals employed in the preferred hydrocracking catalysts of the present invention as hydrogenation components are those of Group VIII, i.e., iron, cobalt, nickel, ruthenium, rhodium, palladium, osmium, iridium and platinum. In addition to these metals, other promoters may also be employed in conjunction therewith, including the metals of Group VIB, e.g., molybdenum and tungsten. The amount of hydrogenating metal in the catalyst can vary within wide ranges. Broadly speaking, any amount between about 0.05 wt % and about 30 wt % may be used. In the case of the noble metals, it is normally preferred to use about 0.05 to about 2 wt % noble metal.

The method for incorporating the hydrogenation metal is to contact the base material with an aqueous solution of a suitable compound of the desired metal wherein the metal is present in a cationic form. Following addition of the selected hydrogenation metal or metals, the resulting catalyst powder is then filtered, dried, pelleted with added lubricants, binders or the like if desired, and calcined in air at temperatures of, e.g., about 371° C. (700° F.) to about 648° C. (200° F.) in order to activate the catalyst and decompose ammonium ions. Alternatively, the base component may be pelleted, followed by the addition of the hydrogenation component and activation by calcining.

The foregoing catalysts may be employed in undiluted form, or the powdered catalyst may be mixed and copelleted with other relatively less active catalysts, diluents or binders such as alumina, silica gel, silica-alumina cogels, activated clays and the like in proportions ranging between about 5 and about 90 wt %. These diluents may be employed as such or they may contain a minor proportion of an added hydrogenating metal such as a Group VIB and/or Group VIII metal. Additional metal promoted hydrocracking catalysts may also be utilized in the process of the present invention which comprises, for example, aluminophosphate molecular sieves, crystalline chromosilicates and other crystalline silicates. Crystalline chromosilicates are more fully described in U.S. Pat. No. 4,363,178.

By one approach, the hydrocracking conditions may include a temperature from about 290° C. (550° F.) to about 468° C. (875° F.), preferably 343° C. (650° F.) to about 445° C. (833° F.), a pressure from about 4.8 MPa (gauge) (700 psig) to about 20.7 MPa (gauge) (3000 psig), a liquid hourly space velocity (LHSV) from about 0.4 to less than about 2.5 hr⁻¹ and a hydrogen rate of about 421 Nm³/m³ (2,500 scf/bbl) to about 2,527 Nm³/m³ oil (15,000 scf/bbl). If mild hydrocracking is desired, conditions may include a temperature from about 35° C. (600° F.) to about 441° C. (825° F.), a pressure from about 5.5 MPa (gauge) (800 psig) to about 3.8 MPa (gauge) (2000 psig) or more typically about 6.9 MPa (gauge) (1000 psig) to about 11.0 MPa (gauge) (1600 psig), a liquid hourly space velocity (LHSV) from about 0.5 to about 2 hr⁻¹ and preferably about 0.7 to about 1.5 hr⁻¹ and a hydrogen rate of about 421 Nm³/m³ oil (2,500 scf/bbl) to about 1,685 Nm³/m³ oil (10,000 scf/bbl).

The embodiment of FIG. 2 also includes a stripping column 110′ as described in FIG. 1, but the stripping column 110′ is not the separation vessel from which the process stream to be heated in the heat exchanger 40 is taken. The stripping column 110′ is in downstream communication with the hydroprocessing reactor 12′. The stripping column 110′ strips a cold liquid hydroprocessed effluent stream which may be the cold flash liquid hydroprocessed effluent stream in line 104 and the hot liquid hydroprocessed effluent stream which may be the hot flash liquid hydroprocessed effluent stream in line 98 by contact with a stripping stream from line 112 to remove volatile materials. The stripping column 110′ provides a stripped hydroprocessed vapor stream in the stripper overhead line 114 and a stripped liquid hydroprocessed stream in a stripper bottoms line 116′. At least a portion of the stripped hydroprocessed liquid stream in the stripper bottoms line 116′ may be fed without heating to the product fractionation column 130 comprising the separation vessel in this embodiment. The product fractionation column 130 may be in downstream communication with the stripped bottoms line 116′ and with the stripping column 110′. The product fractionation column 130 may also be in downstream communication with the hot separator 70, the cold separator 76, the hot flash stripper 94, and the cold flash drum 100. The product fractionation column 130 may comprise more than one fractionation column for separating the stripped hydroprocessed stream into product streams. The product fractionation column 130 may fractionate the stripped hydroprocessed liquid stream in line 116′ by contact with an inert stripping gas stream. The product fractionation column 130 being the separator vessel separates the stripped hydroprocessed liquid stream in line 116′ into an overhead vapor stream in a fractionation overhead line 132 and a bottoms liquid stream in a fractionation bottoms line 134.

The overhead vapor stream in the fractionation overhead line 132 may be condensed in a condenser 133 and separated in a receiver 136 with a portion of the condensed liquid being refluxed back to the product fractionation column 130. The net fractionated overhead liquid stream in line 138 may be further processed or recovered as naphtha product. The bottoms liquid stream in the fractionation bottoms line 134 may be separated between a reboil portion that is reboiled in a reboiler 142 and returned to the product fractionation column 130 and a product stream in a fractionation product line 144. The product stream in the fractionation product line 144 may comprise diesel or an unconverted oil (UCO) stream boiling above the diesel cut point if a feed heavier than diesel is supplied as the hydrocarbon feed stream in line 18. A portion or all of the UCO stream in the fractionation product line 144 may be purged from the process, recycled to the hydroprocessing reactor 12′ or forwarded to a second stage hydrocracking reactor (not shown). If a UCO stream is generated in the fractionation product line 144, other product streams may be taken from a side 131 of the fractionation column 130 including an optional heavy naphtha stream in line 146 from a side cut outlet, a kerosene stream carried in line 148 from a side cut outlet and a diesel stream in diesel line 150 from a side outlet.

The product fractionation column 110 may be operated with a bottoms temperature between about 260° C. (500° F.) and about 385° C. (725° F.), preferably at no more than about 380° C. (715° F.), and at an overhead pressure between about 7 kPa (gauge) (1 psig) and about 69 kPa (gauge) (10 psig).

To reduce utilities in the product fractionation column 130 which is the separation vessel in this embodiment, the process stream in the process line 54′ is taken from the product fractionation column 130 and heated in the heat exchanger 40. The process stream is fed through the third pass 56 and heat exchanged with the hydroprocessed effluent stream in line 50 from the hydroprocessing reactor 12′ in the shell side of the heat exchanger 40. The heat exchanger 40 and particularly the third pass 56 may be in downstream communication, preferably in direct downstream communication, with the product fractionation column 130, separation vessel. The process stream in line 54′ may be taken from an inlet 54i′ in a side 131 of the product fractionation column 130 and between an inlet 132i for the overhead line 132 and an inlet 134i for the bottoms line 134 and preferably below an outlet 116o of the stripped liquid hydroprocessed stream in line 116′ to the product fractionation column 130. The process stream in line 54′ may have an initial boiling point that is intermediate to an initial boiling point of the fractionation overhead vapor stream and the fractionation bottoms liquid stream. The process stream in the process line 54′ is preferably taken as a liquid from a tray in the product fractionation column 130. The process stream is heated in the third pass in the heat exchanger 40 and returned in the return process line 58′ to the product fractionation column 130 through an outlet 58o′ of the return process line above the inlet 54i′. The product fractionation column 130 may be in downstream communication, preferably in direct downstream communication, with the heat exchanger 40 and particularly the third pass 56 of the heat exchanger.

We have found that heating this process stream taken from the product fractionation column 130 and returning it to the fractionation column can reduce the heater duty for the reboiler 142 significantly compared to routinely heating the stripped hydroprocessed liquid stream before it enters the product fractionation column. Moreover, the heating of the process stream in this way also surprising reduces duty required of the overhead condenser 133. These were surprising benefits that were only made possible by using a heat exchanger 40 that can exchange heat between hot streams that have a lower temperature differential such as an STHE. Because the process stream in line 54′ is already hot, effective heat exchange between the process stream and a hydroprocessed effluent stream had not been previously explored.

The rest of the process and apparatus 10′ are as described for FIG. 1.

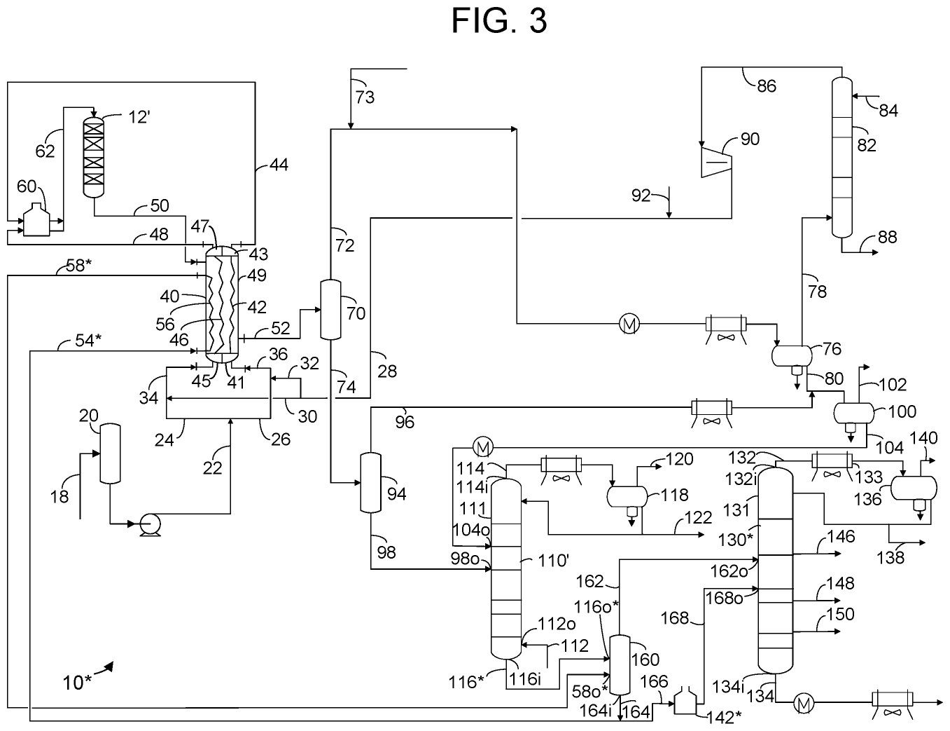

FIG. 3 shows an alternate embodiment of the process and apparatus of FIG. 2 in which the hydroprocessing reactor 12′ is a hydrocracking reactor and the separator vessel is in downstream communication with the stripping column 110′ and the product fractionation column 130* is in downstream communication with the separator vessel. Elements in FIG. 3 with the same configuration as in FIG. 2 will have the same reference numeral as in FIG. 2. Elements in FIG. 3 which have a different configuration as the corresponding element in FIG. 2 will have the same reference numeral but designated with an asterisk symbol (*). The configuration and operation of the embodiment of FIG. 3 is essentially the same as in FIG. 2 with the following exceptions.

In FIG. 3, the separator vessel is a preflash drum 160 which separates the stripped hydroprocessed liquid stream into a preflash overhead vapor stream in line 162 and a preflash bottoms liquid stream in line 164. The preflash overhead vapor stream in line 162 is fed to the product fractionation column 130* and the preflash bottoms liquid stream in line 164 is split between a feed preflash bottoms liquid stream in line 166 and the process stream in line 54*. The preflash bottoms liquid stream in line 166 is fed to a product fractionation feed preheater 142* which supplants the reboiler 142 of FIG. 2 for providing heat to the product fractionation column 130*. A heated preflash bottoms liquid stream from the preheater 142* is fed to the product fractionation column 130* in line 168 through an outlet 168o below an outlet 162o for the preflash overhead vapor stream in line 162.

To reduce utilities in the product fractionation column 130*, the process stream in the process line 54* is taken from a portion of the preflash bottoms liquid stream in in the preflash bottoms line 164 and heated in the heat exchanger 40. The process stream is fed through the third pass 56 and heat exchanged with the hydroprocessed effluent stream in line 50 from the hydroprocessing reactor 12′ in the shell side of the heat exchanger 40. The heat exchanger 40 and particularly the third pass 56 may be in downstream communication, preferably in direct downstream communication, with the preflash drum 160, separation vessel. The process stream in line 54* may be taken from a bottom of the preflash flash drum 160 from an inlet 164i preferably below an outlet 116o* of the stripped liquid hydroprocessed stream in line 116* to the preflash drum 160. The process stream in the process line 54* is heated in the third pass 56 in the heat exchanger 40 and returned in the return process line 58* through an outlet 58o* above the inlet 164i to line 164 and below the outlet 116o* of the line 116* to be preflashed before entering the product fractionation column 130. The heated return process stream in line 58* may alternatively be combined with the stripped hydroprocessed stream in line 116* before it enters the preflash drum 160 together. The preflash drum 160 may be in downstream communication, preferably in direct downstream communication, with the heat exchanger 40 and particularly the third pass 56 of the heat exchanger.

The rest of the process and apparatus 10* are as described for FIG. 2.

### Example

We ran a simulation to determine the reduction in heater duty provided by heat exchanging a process stream taken from the product fractionation column against the hydroprocessed effluent stream compared to heating the stripped hydroprocessed liquid stream before it is fed to the product fractionation column. The return temperature is the temperature of the heated process stream fed to the product fractionation column. The comparison is shown in the Table.

TABLE

| | | Base | Multi stream |
|---|---|---|---|
| | Unit | Case | STHE |
| Stripped Hydroprocessed Liquid | MMBtu/hr | 45 (11) | 0 |
| Stream Exchanger Duty | (MMkcal/hr) | | |
| Product Fractionation Process | MMBtu/hr | 0 | 45 (11) |
| Stream Reboiler Duty | (MMkcal/hr) | | |
| Return Temperature | ° F. (° C.) | | 483 (250) |
| Product Fractionator Reboiler | MMBtu/hr | 98.3 | 84.6 (21.3) |
| Heater Duty | (MMkcal/hr) | (24.7) | |
| Product Fractionator Overhead | MMBtu/hr | 142.6 | 129 (32.5) |
| Condenser Duty | (MMkcal/hr) | (36.0) | |
| Heater Duty Reduction | % | Base | 16 |
| Condenser duty reduction | % | Base | 11 |

Heat exchanging a process stream taken from the product fractionation column against the hydroprocessed effluent stream and returning it to the column in this way can reduce the fractionator reboiler heater duty by up to 13.7 MMBtu/hr (3.5 MMkcal/hr) based on a recent design, worth 350,000 $/year based on US Gulf Coast prices compared with routinely preheating the stripped feed to the product fractionation column. Additionally, the condenser duty is surprisingly reduced as well by a similar duty. This additional benefit is very significant and is made feasible by using a STHE.

### SPECIFIC EMBODIMENTS

While the following is described in conjunction with specific embodiments, it will be understood that this description is intended to illustrate and not limit the scope of the preceding description and the appended claims.

A first embodiment of the disclosure is a hydroprocessing process comprising hydroprocessing a hydrocarbon feed stream in a hydroprocessing reactor with a hydrogen stream over hydroprocessing catalyst to provide hydroprocessed effluent stream; separating the hydroprocessed effluent stream to provide a hydroprocessed vapor stream and a hydroprocessed liquid stream; and separating the hydroprocessed liquid stream in a separation vessel into an overhead vapor stream and a bottoms liquid stream; and heating a hydroprocessing process stream taken from the separation vessel to provide a heated process stream and returning the heated process stream to the separation vessel. An embodiment of the disclosure is one, any or all of prior embodiments in this paragraph up through the first embodiment in this paragraph further comprising heating the process stream by heat exchange. An embodiment of the disclosure is one, any or all of prior embodiments in this paragraph up through the first embodiment in this paragraph further comprising heating the process stream by heat exchange with the hydroprocessed effluent stream. An embodiment of the disclosure is one, any or all of prior embodiments in this paragraph up through the first embodiment in this paragraph further comprising heating the hydrocarbon feed stream and the process stream simultaneously by heat exchange with the hydroprocessed effluent stream. An embodiment of the disclosure is one, any or all of prior embodiments in this paragraph up through the first embodiment in this paragraph further comprising splitting the hydrocarbon feed stream into at least a first feed stream and a second feed stream and simultaneously heating the first hydrocarbon feed stream, the second hydrocarbon feed stream and the process stream by heat exchange with the hydroprocessed effluent stream. An embodiment of the disclosure is one, any or all of prior embodiments in this paragraph up through the first embodiment in this paragraph further comprising performing the heat exchange in a spiral tube heat exchanger. An embodiment of the disclosure is one, any or all of prior embodiments in this paragraph up through the first embodiment in this paragraph further comprising stripping the hydroprocessed liquid stream by contact with a stripping stream to remove volatile materials in the separation vessel to provide the overhead vapor stream and the bottoms liquid stream. An embodiment of the disclosure is one, any or all of prior embodiments in this paragraph up through the first embodiment in this paragraph wherein the process stream is taken from a side of the separation vessel. An embodiment of the disclosure is one, any or all of prior embodiments in this paragraph up through the first embodiment in this paragraph wherein separating the hydroprocessed effluent stream to provide a hydroprocessed vapor stream and a hydroprocessed liquid stream further comprises stripping a hot hydroprocessed liquid stream by contact with a stripping stream to remove volatile materials to provide the hydroprocessed liquid stream and the hydroprocessed vapor stream. An embodiment of the disclosure is one, any or all of prior embodiments in this paragraph up through the first embodiment in this paragraph further comprising taking the process stream from the bottoms liquid stream from the separation vessel. An embodiment of the disclosure is one, any or all of prior embodiments in this paragraph up through the first embodiment in this paragraph further comprising taking a fractionation feed stream from the bottoms liquid stream and fractionating the fractionation feed stream. An embodiment of the disclosure is one, any or all of prior embodiments in this paragraph up through the first embodiment in this paragraph further comprising fractionating the hydroprocessed liquid stream in the separation vessel. An embodiment of the disclosure is one, any or all of prior embodiments in this paragraph up through the first embodiment in this paragraph further comprising taking the process stream from the separation vessel having an initial boiling point that is intermediate to an initial boiling point of the overhead vapor stream and the bottoms liquid stream.

A second embodiment of the disclosure is a separation process comprising separating a stream in a separation vessel to provide an overhead vapor stream and a bottoms liquid stream; taking a process stream from the separation vessel having an initial boiling point that is intermediate to an initial boiling point of the overhead vapor stream and the liquid bottoms stream; and heat exchanging the process stream in a spiral tube heat exchanger. An embodiment of the disclosure is one, any or all of prior embodiments in this paragraph up through the second embodiment in this paragraph further comprising heat exchanging the process stream with a hot stream in a shell side of the spiral tube heat exchanger. An embodiment of the disclosure is one, any or all of prior embodiments in this paragraph up through the second embodiment in this paragraph simultaneously heat exchanging the process stream and another stream with a hot stream in the spiral tube heat exchanger.

A third embodiment of the disclosure is a hydroprocessing apparatus comprising a hydroprocessing reactor; a separation vessel in downstream communication with the hydroprocessing reactor; and a heat exchanger having a pass in downstream communication with the separation vessel and the separation vessel in downstream communication with the pass of the heat exchanger. An embodiment of the disclosure is one, any or all of prior embodiments in this paragraph up through the third embodiment in this paragraph wherein the separation vessel is a stripping column. An embodiment of the disclosure is one, any or all of prior embodiments in this paragraph up through the third embodiment in this paragraph further comprising a stripping column in downstream communication with the hydroprocessing reactor and the separation vessel is in downstream communication with the stripping column. An embodiment of the disclosure is one, any or all of prior embodiments in this paragraph up through the third embodiment in this paragraph wherein the separation vessel is a fractionation column with a reboiler on a bottoms line.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A hydroprocessing process comprising:
hydroprocessing a hydrocarbon feed stream in a hydroprocessing reactor with a hydrogen stream over hydroprocessing catalyst to provide hydroprocessed effluent stream;
separating said hydroprocessed effluent stream to provide a hydroprocessed vapor stream and a hydroprocessed liquid stream; and
separating the hydroprocessed liquid stream in a separation vessel into an overhead vapor stream and a bottoms liquid stream; and
heating a process stream taken from said separation vessel to provide a heated process stream and returning said heated process stream to the separation vessel.

2. The hydroprocessing process of claim 1 further comprising heating said process stream by heat exchange.

3. The hydroprocessing process of claim 2 further comprising heating said process stream by heat exchange with said hydroprocessed effluent stream.

4. The hydroprocessing process of claim 3 further comprising heating said hydrocarbon feed stream and said process stream simultaneously by heat exchange with said hydroprocessed effluent stream.

5. The hydroprocessing process of claim 4 further comprising splitting said hydrocarbon feed stream into at least a first feed stream and a second feed stream and simultaneously heating said first hydrocarbon feed stream, said second hydrocarbon feed stream and said process stream by heat exchange with said hydroprocessed effluent stream.

6. The hydroprocessing process of claim 4 further comprising performing said heat exchange in a spiral tube heat exchanger.

7. The hydroprocessing process of claim 1 further comprising stripping said hydroprocessed liquid stream by contact with a stripping stream to remove volatile materials in said separation vessel to provide said overhead vapor stream and said bottoms liquid stream.

8. The hydroprocessing process of claim 6 wherein said process stream is taken from a side of said separation vessel.

9. The hydroprocessing process of claim 1 wherein separating said hydroprocessed effluent stream to provide a hydroprocessed vapor stream and a hydroprocessed liquid stream further comprises stripping a hot hydroprocessed liquid stream by contact with a stripping stream to remove volatile materials to provide said hydroprocessed liquid stream and said hydroprocessed vapor stream.

10. The hydroprocessing process of claim 9 further comprising taking said process stream from said bottoms liquid stream from said separation vessel.

11. The hydroprocessing process of claim 9 further comprising taking a fractionation feed stream from said bottoms liquid stream and fractionating said fractionation feed stream.

12. The hydroprocessing process of claim 8 further comprising fractionating said hydroprocessed liquid stream in said separation vessel.

13. The hydroprocessing process of claim 11 further comprising taking said process stream from said separation vessel having an initial boiling point that is intermediate to an initial boiling point of said overhead vapor stream and said bottoms liquid stream.

14. A separation process comprising separating a stream in a separation vessel to provide an overhead vapor stream and a bottoms liquid stream; taking a process stream from said separation vessel having an initial boiling point that is intermediate to an initial boiling point of said overhead vapor stream and said liquid bottoms stream; and heat exchanging said process stream in a spiral tube heat exchanger.

15. The separation process of claim 14 further comprising heat exchanging said process stream with a hot stream in a shell side of said spiral tube heat exchanger.

16. The separation process of claim 14 simultaneously heat exchanging said process stream and another stream with a hot stream in said spiral tube heat exchanger.

17. A hydroprocessing apparatus comprising:
a hydroprocessing reactor;
a separation vessel in downstream communication with said hydroprocessing reactor; and
a heat exchanger having a pass in downstream communication with said separation vessel and said separation vessel in downstream communication with said pass of said heat exchanger.

18. The hydroprocessing apparatus of claim 17 wherein said separation vessel is a stripping column.

19. The hydroprocessing apparatus of claim 17 further comprising a stripping column in downstream communication with said hydroprocessing reactor and said separation vessel is in downstream communication with said stripping column.

20. The hydroprocessing process of claim 19 wherein said separation vessel is a fractionation column with a reboiler on a bottoms line.
